(19) United States
(12) Patent Application Publication
(10) Pub. No.: US 2014/0251906 A1
(43) Pub. Date: Sep. 11, 2014

(54) ADDITION OF ALUMINUM REAGENTS TO SULFATE-CONTAINING WASTE STREAM REDUCE SULFATE CONCENTRATION

(71) Applicant: ECOLAB USA INC., Naperville, IL (US)

(72) Inventors: Nicholas S. Ergang, Glen Ellyn, IL (US); Ronald V. Davis, Geneva, IL (US)

(73) Assignee: Ecolab USA Inc., Naperville, IL (US)

(21) Appl. No.: 13/787,365

(22) Filed: Mar. 6, 2013

(51) Int. Cl. C02F 1/52

(52) U.S. Cl. CPC C02F 1/5236
USPC 210/638; 210/724; 210/709; 436/119

(57) ABSTRACT

The invention provides methods and compositions for detection and removal of sulfate from a liquid. The method provides much faster removal of sulfate than the prior art does and does so while requiring the use of far less aluminum. The method involves sequentially adding an acidic to neutral pH generating aluminum agent to the liquid, an alkaline pH generating aluminum agent to the liquid, after having added the acidic to neutral pH generating aluminum agent, and an alkaline calcium agent to the liquid. The most efficient rate possible can be obtained by also using a fluorophore to precisely determine the amount of sulfate in the liquid.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

This invention relates to methods, compositions, and apparatuses useful in the removal of sulfate from liquids. Because sulfates form naturally from the oxidation of sulfide bearing minerals, sulfates are extremely common anions often found in liquids such as waste, effluent, and runoff waters. Because sulfate is a very weak anion it is particularly difficult to separate it from water. This is often an issue of concern because the presence of sulfates in various liquid streams often leads to a number of problems including corrosion, sludge or plug formation, unwanted interactions with other materials in the fluid, and handling difficulties. As a result it is desirable to be able to effectively remove sulfates from various liquids including but not limited to mine drainage effluents (MD), oil well treatment liquids, alumina refinery effluent, ore processing effluent, and industrial process water.

In the context of MD waters, sulfate forms when natural sulfide-based mineral ores or tailings are exposed to air and water. Many regulatory agencies allow for discharge of water which has sulfate levels of between 500 to 1000 ppm. The sulfate level present in MD water however is often 4 to 16 times as great. This sulfate is also typically accompanied by high levels of dissolved metals which necessitates removal of metals (especially toxic heavy metals). While there are numerous technologies that can easily remove metals from water, removal of sulfate is far more problematic. The pH of MD is dependent on other minerals present in the ore and the water is often acidic. Such acidic waters are referred to as Acid Rock Drainage (ARD). The US Forest Service has estimated that there are anywhere from 20,000 to 50,000 mines generating ARD that contaminates 5,000 to 10,000 miles of streams. As a result, a number of prior art techniques have been proposed for removing sulfates from liquids such as MD water. The most widely used methods fall into one of three categories: 1) precipitation, 2) membrane separation and 3) biological treatment.

The most widely practiced MD sulfate precipitation method utilizes addition of lime or calcium hydroxide to create a condition of high calcium sulfate supersaturation allowing precipitation of gypsum. This method, however, is limited by the relatively slow precipitation kinetics and high solubility of gypsum. Further, since the gypsum precipitation is driven by calcium derived from lime of calcium hydroxide, as the precipitation reaction progresses the pH of the solution increases due to the corresponding dissolution of hydroxide derived from lime or calcium hydroxide. Eventually the solution pH reaches a level at which the equilibrium lime or calcium hydroxide derived calcium concentration no longer achieves gypsum supersaturation for the sulfate concentration present and gypsum precipitation stops. As a result of these factors, lime treatment of 3000 to 4000 ppm sulfate mine drainage typically yields water containing 1600 to 2000 ppm sulfate. For very high sulfate mine drainage treated sulfate levels can exceed 5000 ppm. Precipitation of sulfate as a barium salt has also been reported to achieve very low sulfate concentrations. However, this method requires expensive barium reagents and is not practiced. Precipitation of sulfate as the poorly soluble calcium aluminum sulfate hydrate mineral ettringite has also been reported to achieve very low sulfate concentrations. There are several variations of this method that utilize different aluminum reagents and reaction schemes. These methods have the disadvantages of requiring very long holding time and very large reaction vessels or introducing high levels of another anion above its discharge limits and/or they are very complex and difficult to practice.

The most widely applied membrane separation method applied to MD sulfate is reverse osmosis. While this method has proven effective at producing water acceptable for discharge, the method also produces a concentrate stream 20 to 35% of the feed volume and containing nearly all the sulfate originating from the feed water. Reverse osmosis has very high pretreatment requirements to prevent membrane fouling, is energy intensive and can be poorly suited to remote mine areas. The difficult to treat concentrate is typically stored in a segregated waste pond or is returned to the volume of MD water being treated. Segregation of the concentrate is not a permanent solution and simply postpones treatment of the concentrate. Recycle of the concentrate to the MD water results in steadily increasing MD water sulfate. When recycled MD is a component of process water utilized at a mine site this increase in sulfate can adversely impact production and eventually require segregation or treatment.

Biological treatment of MD typically utilizes sulfate reducing bacteria to convert sulfate to the more easily removed sulfide. Such treatment has been successfully practiced to treat relatively small volumes. Reaction rate is relatively slow and is surface controlled so large reactors would be required to treat high flow rates of sulfate contaminated water. Further, an organic reagent is typically required to provide an energy source for the microorganisms, toxic contaminants present in mine water must be removed prior to biological treatment and pH adjustment may be necessary to insure optimum microbiological activity. The energy reagent is typically an inexpensive organic waste material such as manure, agricultural waste or waste glycerin. As a result, the method is not well suited to areas where such materials are not available or where transport of the material is cost prohibitive.

Thus there is clear need and utility for novel methods, compositions, and apparatuses for improving the removal of sulfate from liquids, in particular ARD from MD waters. The art described in this section is not intended to constitute an admission that any patent, publication or other information referred to herein is “prior art” with respect to this invention, unless specifically designated as such. In addition, this section should not be construed to mean that a search has been made or that no other pertinent information as defined in 37 CFR §1.56(a) exists. Additional features and advantages are described herein, and will be apparent from, the following Detailed Description.

### BRIEF SUMMARY OF THE INVENTION

To satisfy the long-felt but unsolved needs identified above, at least one embodiment of the invention is directed towards a method of removing sulfates from a liquid comprising the steps of: adding an acidic to neutral pH generating aluminum agent to the liquid, adding an alkaline pH generating aluminum agent to the liquid after having added the acidic to neutral pH generating aluminum agent, and adding an alkaline calcium agent to the liquid after or while adding the neutral generating aluminum agent, the method producing a sulfate containing precipitate. The acidic to neutral pH generating aluminum reagent may be added with mixing to the sulfate-containing solution to achieve a pH of 1.0 to 7.0. The precipitate may contains substantially no ettringite. The acidic to neutral pH generating aluminum reagent may be selected from the list consisting of: polyaluminum chloride, aluminum chlorohydrates, aluminum chloride, aluminum nitrate, aluminum sulfate, acidified aluminum oxide, acidified aluminum hydroxide, acidified aluminosilicate, and any combination thereof. The alkaline pH generating aluminum reagent may be one item selected from the list consisting of: sodium aluminate, calcium aluminate, aluminum hydroxide, aluminum oxide, aluminosilicate, and any combination thereof. The calcium source may be one item selected form the list consisting of: lime, hydrated lime, calcium carbonate, fly ash, blast furnace slag, calcium silicate, calcium chloride, calcium nitrate, calcium bromide and any combination thereof. The precipitate may form at a rate of at least twice that of an ettringite forming precipitation reaction. The liquid may be from mine drainage effluent (MD), oil well liquid, gas well liquid, oil shale process liquid, alumina refinery effluent, ore processing water, paper production fluids, flue gas desulfurization water, landfill water, industrial process water, and water, and any combination thereof. The liquid may be pretreated by media filtration, membrane filtration, microfiltration, nanofiltration, reverse osmosis and forward osmosis and any combination thereof.

The progress of the formation of the precipitate may be determined by the steps of: adding a fluorophore to the partially treated water prior to the addition of the alkaline calcium reagent, measuring the emission of the fluorophore after addition of the alkaline calcium reagent and correlating the emission with the degree of sulfate precipitated out of the liquid. The fluorophore may be one item selected from the list consisting of: 1,3,6,8-pyrenetetrasulfonic acid and salts thereof, 1-pyrenesulfonic acid and salts thereof, 1-pyrenecarboxylic acid and salts thereof, 1-pyreneacetic acid and salts thereof, 1-methylaminopyrene and salts thereof, 8-hydroxy-1,3,6-pyrenetrisulfonic acid and salts thereof, 1-aminopyrene and salts thereof, γ-oxo-1-pyrenebutyric acid and salts thereof, 1-naphthalenesulfonic acid and salts thereof, 2-napthalenesulfonic acid and salts thereof, 4-hydroxy-1-naphthalenesulfonic acid and salts thereof, 1,5-naphthalenedisulfonic acid and salts thereof, 1-amino-5-naphthalenesulfonic acid and salts thereof, 6,7-dihydroxy-2-naphthalenesulfonic acid and salts thereof, 6-hydroxy-2-naphthalenesulfonic acid and salts thereof, 1-hydroxy-2-naphthoic acid and salts thereof, 2-hydroxy-1-naphthoic acid and salts thereof, 3-hydroxy-2-naphthoic acid and salts thereof, 2,6-naphthalenedicarboxylic acid and salts thereof, 1-naphthylacetic acid and salts thereof, 1-naphthoxylactic acid and salts thereof, 1-naphthoxyacetic acid and salts thereof, 2-naphthoxyacetic acid and salts thereof, 1-naphthalenephosphonic acid and salts thereof, 1-aminonaphthalene and salts thereof, N-allyl-4-(2-N′,N′-dimethylaminoethoxy)naphthalimide methyl sulfate quaternary salt, SOM fluorescent compound, a polymer containing an SOM fluorescent compound, GQW polymer (red), GQW polymer purple), and any combination thereof.

The method may further comprises the steps of determining the pH of the liquid, determining the sulfate, concentration of the liquid, and adding an amount of at least one of alkaline pH generating aluminum agent, acidic to neutral pH generating aluminum agent, and alkaline calcium agent added to the liquid in an amount predetermined to be optimal for the pH and the sulfate concentration of the liquid, wherein the sulfate concentration is determined by adding a fluorophore to the liquid, before adding the acidic to neutral pH generating aluminum agent, measuring the fluorescence of the liquid before and after the addition of the acidic to neutral pH generating aluminum agent, and correlating the change in fluorescence to the concentration of sulfate in the liquid.

At least one embodiment of the invention is directed towards a method of determining the sulfate concentration of a liquid, the method comprising the steps of: adding a fluorophore to the liquid, adding an acidic to neutral pH generating aluminum agent, measuring the fluorescence of the liquid before and after the addition of the acidic to neutral generating aluminum agent, and correlating the change in fluorescence to the concentration of sulfate in the liquid.

Additional features and advantages are described herein, and will be apparent from, the following Detailed Description.

### BRIEF DESCRIPTION OF THE DRAWINGS

A detailed description of the invention is hereafter described with specific reference being made to the drawings in which:

FIG. 1 is a graph illustrating how compositions used in the invention perform in removing sulfate from water when fed separately.

FIG. 2 is a graph illustrating how compositions used in the invention perform in removing sulfate from water when fed sequentially.

FIG. 3 is a graph illustrating how fluorescent emissions can be inversely related to sulfate concentrations.

FIG. 4 is a graph illustrating how fluorescent emission can be used to measure the progress in removing sulfate from a liquid.

For the purposes of this disclosure, like reference numerals in the figures shall refer to like features unless otherwise indicated. The drawings are only an exemplification of the principles of the invention and are not intended to limit the invention to the particular embodiments illustrated.

### DETAILED DESCRIPTION OF THE INVENTION

The following definitions are provided to determine how terms used in this application, and in particular how the claims, are to be construed. The organization of the definitions is for convenience only and is not intended to limit any of the definitions to any particular category.

“Spectrometry” and “Spectroscopy” means the process of analyzing the interaction between a sample of matter and electromagnetic radiation to determine one or more physical properties of the sample of matter. Forms of electromagnetic radiation used include but are not limited to one or more of microwave, terawave, infrared, near infrared, visible, ultraviolet, x-ray, radiation. The analysis includes measurements of one or more of the radiation's absorption, emission, fluorescence, colorometrics, color changes, reflection, scattering, inelastic scattering, impedance, refraction, and resonance by the sample of matter.

“Fluorophore” means a composition of matter which emits fluorescent light when irradiated with light of an appropriate wavelength, it includes but is not limited to fluorescent: dyes, pigments, polymers, metal ions, metal complexes, and any combination thereof.

“Consisting Essentially of” means that the methods and compositions may include additional steps, components, ingredients or the like, but only if the additional steps, components and/or ingredients do not materially alter the basic and novel characteristics of the claimed methods and compositions.

“SOM Fluorescent Compound” means a fluorescent compound as described in U.S. Pat. No. 6,358,746 of the formula:

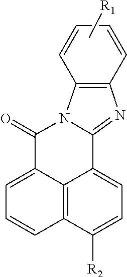

wherein R1 and R2 are either both SO3M, or one of R1 and R2 is SO3M and the other is COOM, where M is selected from the group consisting of H, Na, K, Rb, Cs, Li or ammonium.

“GQW Polymer (Red)” means a tagged treatment polymer as described in U.S. Pat. No. 6,645,428 selected from the group consisting of: GaQjWt (1) wherein G is selected from the group consisting of:

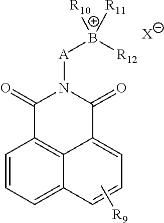

wherein R9 is selected from the group consisting of hydrogen, alkyl, alkoxy, halogen, sulfonic acid and its salts, phosphonic acid and its salts, dialkylamino, allyloxy and vinylbenzyloxy; R10 and R11 are alkyl; R12 is selected from the group consisting of allyl, 2-hydroxy-3-allyloxypropyl, vinylbenzyl, 3-methacrylamidopropyl, 3-acrylamidopropyl, 2-acryloxyethyl and 2-methacryloxyethyl; A is selected from the group consisting of alkyl, alkoxyalkyl, alkylamidoalkyl, aryl or nonexistent; with the proviso that when A is nonexistent, B is nitrogen (N) and B is bonded directly to the imide nitrogen; B is sulfur or nitrogen with the proviso that when B is sulfur only one of R10 or R11 is present; and X is an anionic counter ion; wherein Q is selected from the group consisting of acrylic acid and salts thereof, methacrylic acid and salts thereof, maleic acid and salts thereof, maleic anhydride, acrylamide, crotonic acid, acrylamidomethylpropane sulfonic acid and salts thereof; wherein W is selected from the group consisting of: acrylic acid and salts thereof, methacrylic acid and salts thereof, itaconic acid and salts thereof, maleic acid and salts thereof, maleic anhydride, crotonic acid and salts thereof, acrylamide, methacrylamide, vinyl sulfonic acid, styrene sulfonate, N-tertbutylacrylamide, N-isopropylacrylamide, butoxymethylacrylamide, N,N-dimethylacrylamide, N,N-diethylacrylamide, dimethylaminoethyl acrylate methyl chloride quaternary salts, dimethylaminoethyl acrylate benzyl chloride quaternary salts, dimethylaminoethyl acrylate methyl sulfate quaternary salt, dimethylaminoethyl methacrylate methyl sulfate quaternary salt, dimethylaminoethyl acrylamide methyl sulfate quaternary salts, dimethylaminopropy acrylamide methyl sulfate quaternary salts, dimethylaminopropyl methacrylamide methyl sulfate quaternary salts, diallyldimethyl ammonium chloride, N-vinyl formamide, dimethylamino ethyl methacrylate acid salts (including, but not limited to, sulfuric acid and hydrochloride acid salts), dimethylaminoethyl methacrylate methyl chloride quaternary salt, dimethylaminoethyl methacrylate benzyl chloride quaternary salt, methacrylamidopropyl trimethyl ammonium chloride, acrylamidopropyl trimethyl ammonium chloride, methylene bis acrylamide, triallylamine, acid salts of triallylamine, ethylene glycol dimethacrylate, hydroxymethylacrylate, hydroxyethylacrylate, hydroxypropylacrylate, hydroxypropylmethacrylate, diethylene glycol dimethacrylate, triethylene glycol dimethylacrylate, polyethylene glycol dimethacrylate, glycidyl methacrylate, acrylamidomethylpropane sulfonic acid and the sodium salt thereof, vinyl alcohol, vinyl acetate, and N-vinylpyrrolidone; with the proviso that Q and W cannot both be the same; wherein a is from about 0.001 to about 10.0 mole percent; wherein j is from about 0 to about 99.999 mole percent; wherein t is from about 0 to about 99.999 mole percent; and wherein a+j+t=100; GaQvWfSe (2) wherein G is as previously defined; wherein Q is as previously defined; wherein W is as previously defined, with the proviso that Q and W cannot both be the same; wherein S is selected from the group consisting of sulfomethylacrylamide and sulfoethylacrylamide; wherein a is from about 0.001 to about 10.00 mole percent; wherein v is from about 0 to about 97.999 mole percent; wherein f is from about 1 to about 97.999 mole percent; wherein c is from about 1 to about 40 mole percent; and wherein a+v+f+c=100.

“GQW Polymer (Purple)” means a tagged treatment polymer as described in U.S. Pat. No. 7,601,789 selected from the group consisting of: GaQjWt (1) wherein G is selected from the group consisting of:

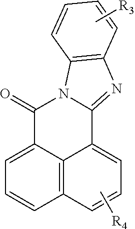

wherein R3 is sulfonic acid and its salts or carboxylic acid and its salts or allyloxy or vinylbenzyloxy; and R4 is sulfonic acid and its salts or carboxylic acid and its salts or allyloxy or vinylbenzyloxy; with the proviso that when one of R3 or R4 is sulfonic acid and its salts or carboxylic acid and its salts, the other must be allyloxy or vinylbenzyloxy: wherein Q is selected from the group consisting of acrylic acid and salts thereof, methacrylic acid and salts thereof, maleic acid and salts thereof, maleic anhydride, acrylamide, crotonic acid, acrylamidomethylpropane sulfonic acid and salts thereof; wherein W is selected from the group consisting of: acrylic acid and salts thereof, methacrylic acid and salts thereof, itaconic acid and salts thereof, maleic acid and salts thereof, maleic anhydride, crotonic acid and salts thereof, acrylamide, methacrylamide, vinyl sulfonic acid, styrene sulfonate, N-tertbutylacrylamide, N-isopropylacrylamide, butoxymethylacrylamide, N,N-dimethylacrylamide, N,N-diethylacrylamide, dimethylaminoethyl acrylate methyl chloride quaternary salts, dimethylaminoethyl acrylate benzyl chloride quaternary salts, dimethylaminoethyl acrylate methyl sulfate quaternary salt, dimethylaminoethyl methacrylate methyl sulfate quaternary salt, dimethylaminoethyl acrylamide methyl sulfate quaternary salts, dimethylaminopropyl acrylamide methyl sulfate quaternary salts, dimethylaminopropyl methacrylamide methyl sulfate quaternary salts, diallyldimethyl ammonium chloride, N-vinyl formamide, dimethylamino ethyl methacrylate acid salts (including, but not limited to, sulfuric acid and hydrochloride acid salts), dimethylaminoethyl methacrylate methyl chloride quaternary salt, dimethylaminoethyl methacrylate benzyl chloride quaternary salt, methacrylamidopropyl trimethyl ammonium chloride, acrylamidopropyl trimethyl ammonium chloride, methylene bis acrylamide, triallylamine, acid salts of triallylamine, ethylene glycol dimethacrylate, hydroxymethylacrylate, hydroxyethylacrylate, hydroxypropylacrylate, hydroxypropylmethacrylate, diethylene glycol dimethacrylate, triethylene glycol dimethylacrylate, polyethylene glycol dimethacrylate, glycidyl methacrylate, acrylamidomethylpropane sulfonic acid and the sodium salt thereof, vinyl alcohol, vinyl acetate, and N-vinylpyrrolidone; with the proviso that Q and W cannot both be the same; wherein a is from about 0.001 to about 10.0 mole percent; wherein j is from about 0 to about 99.999 mole percent; wherein t is from about 0 to about 99.999 mole percent; and wherein a+j+t=100; GaQvWfSc (2) wherein G is as previously defined; wherein Q is as previously defined; wherein W is as previously defined, with the proviso that Q and W cannot both be the same; wherein S is selected from the group consisting of sulfomethylacrylamide and sulfoethylacrylamide; wherein a is from about 0.001 to about 10.00 mole percent; wherein v is from about 0 to about 97.999 mole percent; wherein f is from about 1 to about 97.999 mole percent; wherein c is from about 1 to about 40 mole percent; and wherein a+v+f+c=100.

In the event that the above definitions or a description stated elsewhere in this application is inconsistent with a meaning (explicit or implicit) which is commonly used, in a dictionary, or stated in a source incorporated by reference into this application, the application and the claim terms in particular are understood to be construed according to the definition or description in this application, and not according to the common definition, dictionary definition, or the definition that was incorporated by reference. In light of the above, in the event that a tern can only be understood if it is construed by a dictionary, if the term is defined by the Kirk-Othmer Encyclopedia of Chemical Technology, 5th Edition, (2005), (Published by Wiley, John & Sons, Inc.) this definition shall control how the term is to be defined in the claims.

At least one embodiment of the invention is directed towards a method of removing sulfates from a liquid. The method comprises the steps of 1) adding an acidic to neutral pH generating aluminum agent to the liquid, 2) adding an alkaline pH generating aluminum agent to the liquid after having added the acidic to neutral pH generating aluminum agent, and 3) adding an alkaline calcium agent to the liquid after or while adding the neutral pH generating aluminum agent. This three steps removal process result in the formation of an amorphous calcium aluminate sulfate precipitate.

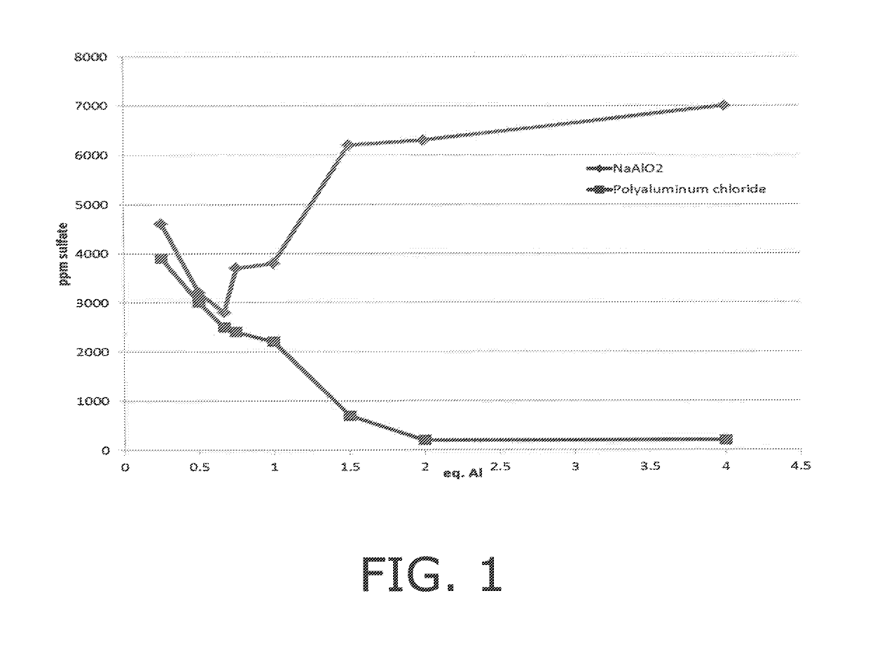

Although each of these reagents has been previously used to precipitate sulfate from water, the specific order of operations in the method leads to a number of wholly unexpected beneficial results. As illustrated in FIG. 1 an acidic to neutral pH generating aluminum agent followed by alkaline calcium will effectively precipitate out sulfate but only with very high dosages of aluminum and only via slow reaction kinetics. At low dosages an alkaline pH generating aluminum agent followed by alkaline calcium performs about as well as an acidic to neutral pH generating aluminum reagent but once the aluminum dosage exceeds a certain threshold, the alkaline pH generating aluminum agent becomes much less effective at removing sulfate.

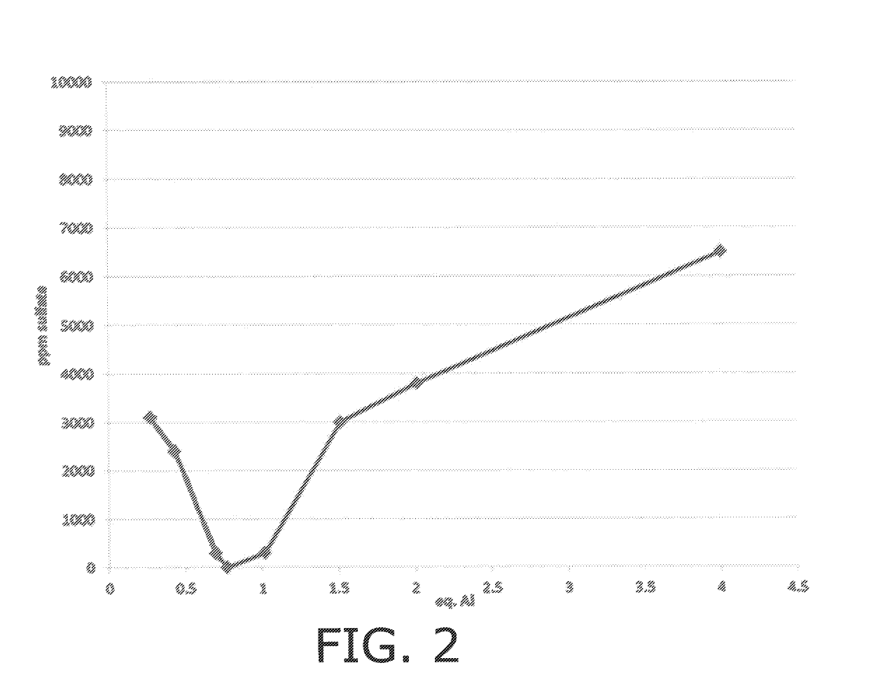

In contrast the specific order inherent in the inventive process results in an unexpected synergy which is far greater than the sum of the individual parts. As shown in FIG. 2 when the two are sequentially led and followed by alkaline calcium, the rate of sulfate removal is much faster and can be accomplished with a much smaller dosage of aluminum. In the experimental example sequential feeding resulted in virtually total sulfate removal with a dosage of only 0.7 equivalents of the sequentially fed aluminum while acidic only Al reagents required a dosage of at least 2 Al equivalents and alkaline-only Al reagents could not achieve this degree of removal at any dosage. This result was quite unexpected given the performance of both Al reagents separately.

Without being limited by a particular theory or design of the invention or of the scope afforded in construing the claims, it is believed that the order of the addition causes the superior performance. While rather disappointing at precipitating sulfate on their own, acidic to neutral pH generating aluminum agents are believed to be able to form large hydrated aluminum sulfate complex ions. It is believed that the unique electrostatic properties of these complex ions prevent the sulfate from being easily released at higher pH levels and thus make the subsequently added alkaline pH generating aluminum agents far more effective at precipitating sulfate. Further, it is believed that such a process favors formation of an amorphous precipitate rather than crystalline precipitates such as ettringite.

Evidence that the invention utilizes novel reaction mechanisms are indicated by the absence of mineral calcium aluminate sulfates such as ettringite in the resulting precipitate. As described in Scientific Paper Ettringite Precipitation vs. Nano-Filtration for Efficient Sulphate Removal from Mine Water, by E Janneck et al., International Mine Water Association Annual Conference, Edited by McCullough Lund and Wyse pp. 206I-206R (2012) (hereinafter “Janneck”), U.S. Pat. Nos. 5,443,730, and 5,547,588, and US Published Patent Application 2012/0031850 typical aluminum based sulfate precipitation processes form mineral ettringite and therefore have slow reaction kinetics. The different and faster reaction kinetics in the invention results in an absence of ettringite.

In at least one embodiment the sulfate-containing water is pretreated prior to the application of the method of the invention. Representative examples of the pretreatment include but are not limited to membrane separation, microfiltration, nanofiltration, reverse osmosis, forward osmosis and sand filtration.

In at least one embodiment the acidic to neutral pH generating aluminum reagent is a solid, solution, or slurry that generates an acidic to neutral pH when added to distilled water. Representative examples of the acidic to neutral pH generating aluminum reagent include but are not limited to polyaluminum chloride, aluminum chlorohydrates, aluminum chloride, aluminum nitrate, aluminum sulfate, acidified aluminum oxide, acidified aluminum hydroxide, acidified aluminosilicate, and any combination thereof.

In at least one embodiment the alkaline pH generating aluminum reagent is a solid, solution or slurry that generates an alkaline pH when added to distilled water. Representative examples of the alkaline pH generating aluminum reagent include but are not limited to sodium aluminate, calcium aluminate, aluminum hydroxide, aluminum oxide, aluminosilicate, and any combination thereof.

In at least one embodiment the alkaline calcium source is a solid, solution or slurry. Representative examples of the alkaline calcium source include but are not limited to lime, hydrated lime, calcium carbonate, calcium silicate, and any combination thereof. The alkaline calcium source can one reagent or may be a combination of reagents that together yield the alkaline calcium source. The reagents may be divided into one or more calcium sources and one or more alkalinity sources. The combination reagents may be fed together to the water in a single feed line or may be fed separately through different feed lines. Representative examples of the calcium source include but are not limited to calcium chloride, calcium nitrate and calcium bromide. Representative examples of the alkalinity source include but are not limited to sodium hydroxide and potassium hydroxide.

In at least one embodiment the acidic to neutral pH generating aluminum reagent is added with mixing to the sulfate-containing solution to achieve a pH of 1.0 to 7.0. If needed, an acid or base can be added to the water to adjust the pH to the desired range. A pH of 2.5 to 4.5 is preferred.

In at least one embodiment the alkaline pH generating aluminum reagent is added to the water with mixing to achieve a higher pH.

In at least one embodiment the alkaline calcium source is added with mixing to achieve a pH of 10.0 to 13.0 with a pH of at least 12 preferred and the resulting suspension is stirred for a time necessary to achieve the desired treated sulfate concentration.

In at least one embodiment the alkaline calcium source is added with mixing to achieve a desired calcium concentration and the resulting suspension is stirred for a time necessary to achieve the desired treated sulfate concentration.

In at least one embodiment the ratio of acidic to neutral pH generating aluminum reagent to alkaline pH generating aluminum reagent is between 15:1 and 1:15. In at least one embodiment the dosage of added calcium atomic equivalents to sulfate molecular equivalents is between 1:100 and 10:1. In at least one embodiment the dosage of added aluminum atomic equivalents to sulfate molecular equivalents is between 1:100 and 10:1.

In at least one embodiment the reaction of sulfate with the aluminum reagents takes place very quickly, typically less than a minute after reagent addition. As a result, the steps, especially the first two steps, can be performed in separate stages or can be performed in a single stage with separate injection points. For example, via inline injection of the reagents at different locations within a pipe containing flowing feed water.

In at least one embodiment the second and third steps are easily combined such that the alkaline pH generating aluminum reagent and the alkaline calcium source are added simultaneously. When steps 2 and 3 are combined the two reagents can be mixed and fed as a single combined reagent, can be added separately but simultaneously or could be fed as a single reagent that has the properties of both the alkaline pH generating aluminum reagent and the alkaline calcium reagent.

In at least one embodiment the optimal residence time for the calcium source is dependent on the initial feed water sulfate, feed water pH and desired treated sulfate level. While the residence time can be as long as (or longer than) an hour it is typically no more than 30 minutes even for waters containing 8000 ppm sulfate.

In at least one embodiment before, during, and/or after any of step 1, 2, and/or 3 aluminum salts such as aluminum cation salts, and/or complex aluminum oxide cation salts, which contain anionic counter ions, can be utilized as either the acidic to neutral aluminum reagent or the alkaline aluminum reagent. The use of such reagents in the method of the invention enhances the precipitation rate and efficiency without exceeding the discharge limit of the anion of the aluminum salt.

This invention, along with many prior art methods for removing sulfates from liquids are highly dependent on such factors as pH and sulfate content. While determining pH is relatively straightforward, determining sulfate content is rather difficult. In fact the chemical difficulties are compounded by the fact that many sulfate bearing liquids such as MD and ARD are “moving targets” in which repeated and frequent rain, evaporation, and condensation, constantly vary the relative concentration of the sulfates. In addition, when the mine drainage is also a process fluid that is recycled to the process after use then changes in the process can alter the concentration of sulfate of the water. For example, in a closed loop heap leach operation the concentration of sulfate within the loop will climb if the sulfate is not removed by treatment. Sulfate concentration in MD can vary widely over months, weeks, days, and even hours. Seasonal variations in MD sulfate are often on the order of thousands of ppm. Due to the high cost of manpower and analytical equipment required to perform frequent measurement of MD composition for modification and adjustment of treatment system operating parameters, MD treatment systems are typically not optimized to peak performance and minimal treatment cost. As a result automated MD feed water monitoring and treatment system control is generally not available.

An example of this can be understood by referring again to FIG. 2. Displayed therein are the performance results of adding reagents to a sample with 8000 ppm sulfate at a specific pH. While under those conditions approximately 0.7 equivalents of Al from a 1:1 ratio of alkaline to acidic agent to 1 sulfate equivalent completely precipitated out the sulfates. The steep rues on the curve show that substantially more or less than that dosage would have been less effective. A different pH and different sulfate content, however, would alter the graph's properties and thus the optimal dose of the aluminum reagents. As a result, an effective and simple method of determining the sulfate content of a liquid is highly desirable.

In at least one embodiment a method is used to determine the concentration of sulfate in a liquid. The method comprises the steps of adding an acidic to neutral pH generating aluminum reagent and a spectroscopically reactive agent to the liquid and measuring a spectroscopic change as a function of the concentration of the acidic to neutral pH generating aluminum reagent, the concentration of the spectroscopically reactive agent and the sulfate concentration, and correlating that change with a predetermined value associated with a specific concentration of sulfate. The spectroscopically reactive agent may be a fluorophore.

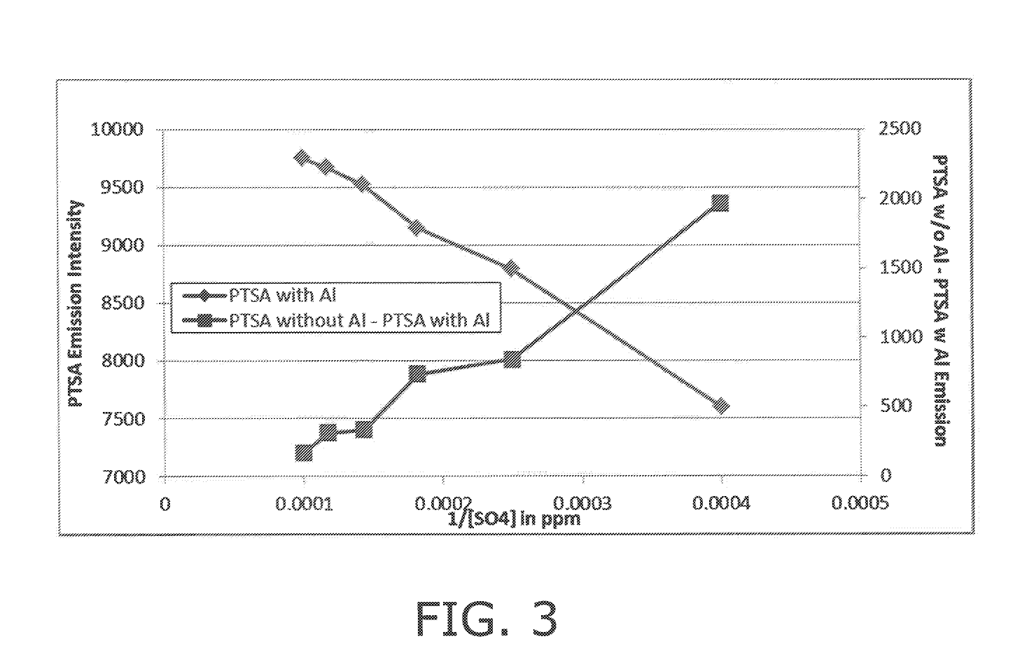

In at least one embodiment the presence of the acidic to neutral pH generating aluminum reagent with the fluorophore in the presence of sulfate yields a decrease in emission of the fluorophore compared to the fluorophore emission in the absence of the aluminum reagent. Because the decrease in emission is a function of the concentration of sulfate present in the liquid its measurement can be used to calculate the sulfate concentration. For example as illustrated in FIG. 3 1,3,6,8-pyrenetetrasulfonate's change in fluorescence emission in the presence of polyaluminum chloride differs at various concentrations of sulfate. The emission changes are directly proportional to a function of the concentration (or inverse thereof) of sulfate in the liquid. Presumably the emission change is a result of competition between sulfate and the fluorophore to complex with the aluminum agent. When the fluorophore is complexed it is effectively removed from solution and it's fluorescence is reduced.

In at least one embodiment the fluorophore is added to the target liquid prior to addition of the acidic to neutral pH generating aluminum reagent. The fluorophore and the acidic to neutral aluminum reagent are added to the water in amounts that are known or which can be readily determined. The method can be practiced on a portion of the feed water feed to the treatment system, for example a side stream of the feed water to which the fluorophore and acidic to neutral pH generating aluminum reagent are added, or the method can be performed on a portion of the bulk water to which the fluorophore has been added and then treated with the acidic to neutral pH generating aluminum reagent as part of the sulfate removal method.

Representative examples of fluorophores useful in this method include but are not limited to 1,3,6,8-pyrenetetrasulfonic acid, 1-pyrenesulfonic acid, 8-hydroxy-1,3,6-pyrenetrisulfonic acid, γ-oxo-1-pyrenebutyric acid, 1-pyrenecarboxylic acid, 1,5-naphthalenedisulfonic acid, 1-naphthalene sulfonic acid, and/or one or more of the fluorophores and methods of their use described in U.S. Pat. Nos. 7,179,384, 6,312,644, 6,358,746, 7,601,789, 7,875,720, 6,645,428, and 6,280,635, and U.S. patent application Ser. No. 13/730,087, and any combination thereof.

The method can be performed intermittently and/or continuously.

By determining the sulfate concentration of the feed water, as well as the pH of the target liquid the proper/optimal dosage of one or more reagents useful in removing sulfate from that liquid can be identified and applied. In at least one embodiment the emission changing detection method is used to determine the amount of the acidic and/or alkaline aluminum agents to be used in the above mentioned 3-step sequential addition removal method. In at least one embodiment the emission changing detection method is used to determine the amount of one or more reagents to be added is according to one or more of the sulfate removing methods described in one or more of: U.S. Pat. Nos. 5,547,588, 7,914,676, 5,443,730, 4,059,513, 6,811,704, 6,280,630, US Published Patent Application 2012/0031850, UK Patent Application. GB 4449996A, Japanese Patent Application Number 2001-356395, European Patent Documents DE4005469, EP0584502, EP0250626, EP0623559, and scientific papers Janneck, and Clean Technologies for the Treatment of Coal Acid Mining Effluents, by Jorge Rubio et al, Fifth International Conference on Clean Coal Technologies, Zaraqoza, Spain, pp. 1-11, (2011).

At least one embodiment is a method of determining the performance of step 3 of the three step method, the final precipitation stage. This method involves adding a fluorophore to the partially treated water prior to the addition of the alkaline calcium reagent and then monitoring the emission of the fluorophore after addition of the alkaline calcium reagent. It has been discovered that the emission of the fluorophore decreases at a rate that is proportional to the decrease in concentration of sulfate which is a result of precipitation. As a result, consumption of the fluorophore, as indicated by comparison of emission of the fluorophore in the presence and absence of the alkaline calcium reagent, is an indicator of consumption of sulfate. Operating parameters of the precipitation stage can then be adjusted to achieve the desired level of consumption.

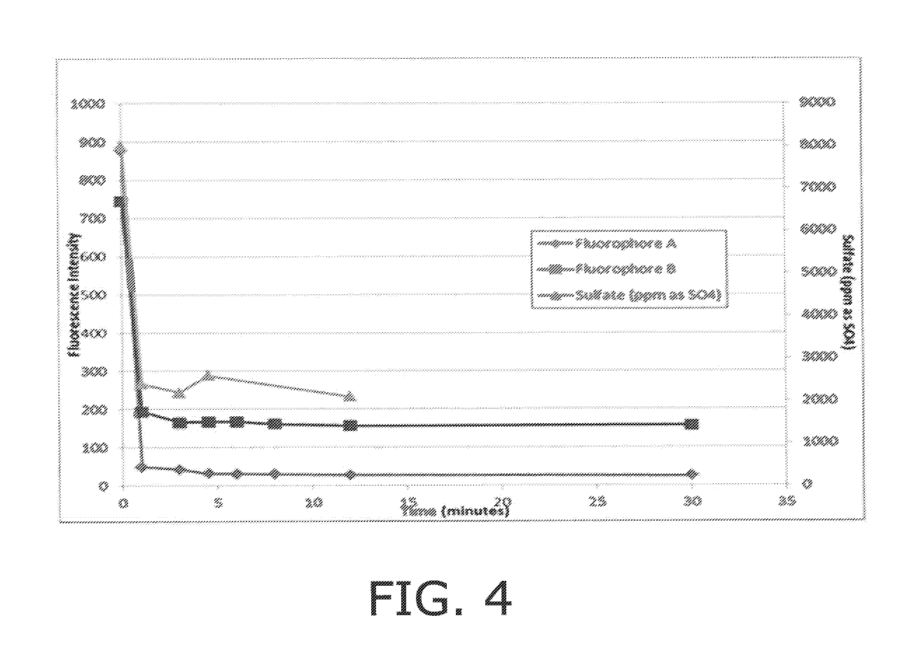

Examples of parameters that can be adjusted to yield the desired level of sulfate removal include the residence time of the treated water within the precipitation stage, the rate of solids removal from the water, the temperature of the water and the dose of either or both aluminum reagents. The method can be performed on a portion of the aluminum treated water fed to the precipitation stage, for example a side stream to which the fluorophore is added followed by the alkaline calcium reagent, or the method can be performed by adding the fluorophore to the bulk water fed to the precipitation stage and withdrawing a portion of the bulk water for fluorescence measurement. Examples of fluorophores useful in this method are 1,3,6,8-pyrenetetrasulfonic acid, 1-pyrenesulfonic acid, 8-hydroxy-1,3,6-pyrenetrisulfonic acid, γ-oxo-1-pyrenebutyric acid, 1-pyrenecarboxylic acid, 1,5-naphthalenedisulfonic acid, 1-naphthalene sulfonic acid, acrylamide acrylate copolymer containing 1,3,6-pyrenetrisulfonic acid pendant groups, as well as any of the fluorophores (and methods of their use) mentioned above for measuring sulfate concentration, and any combination thereof. The method can be performed intermittently but continuous measurement is preferred. FIG. 4 demonstrates the response of a sulfomethylated acrylate acrylamide copolymer containing a fluorescent pendant group, 1,3,6,8-pyrenetetrasulfonic acid and dissolved sulfate to the addition of calcium hydroxide slurry to a solution treated with polyaluminum chloride and sodium aluminate at pH 12.5. FIG. 4 also demonstrates how rapidly the inventive method removes sulfate from liquids.

While this invention may be embodied in many different forms, there are described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments described herein and/or incorporated herein. In addition the invention encompasses any possible combination that also specifically excludes any one or some of the various embodiments described herein and/or incorporated herein.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more, (e.g. 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range. All percentages, ratios and proportions herein are by weight unless otherwise specified.

This completes the description of the preferred and alternate embodiments of the invention. Those skilled in the art may recognize other equivalents to the specific embodiment described herein which equivalents are intended to be encompassed by the claims attached hereto.

1. A method of removing sulfates from a liquid comprising the steps of: adding an acidic to neutral pH generating aluminum agent to the liquid, adding an alkaline pH generating aluminum agent to the liquid after having added the acidic to neutral pH generating aluminum agent, and adding an alkaline calcium agent to the liquid after or while adding the neutral pH generating aluminum agent, the method producing a sulfate containing precipitate.

2. The method of claim 1 wherein the acidic to neutral pH generating aluminum reagent is added with mixing to the sulfate-containing solution to achieve a pH of 1.0 to 7.0.

3. The method of claim 1 wherein alkaline calcium source is added with mixing to achieve a pH of 10.0 to 13.0.

4. The method of claim 1 wherein precipitate contains substantially no ettringite.

5. The method of claim 1 wherein the acidic to neutral pH generating aluminum reagent is selected from the list consisting of polyaluminum chloride, aluminum chlorohydrates, aluminum chloride, aluminum nitrate, aluminum sulfate, acidified aluminum oxide, acidified aluminum hydroxide, acidified aluminosilicate, and any combination thereof.

6. The method of claim 1 wherein the alkaline pH generating aluminum reagent is one item selected from the list consisting of: sodium aluminate, calcium aluminate, aluminum hydroxide, aluminum oxide, aluminosilicate, and any combination thereof.

7. The method of claim 1 wherein the calcium source is one item selected form the list consisting of: lime, hydrated lime, calcium carbonate, fly ash, blast furnace slag, calcium silicate, calcium chloride, calcium nitrate, calcium bromide and any combination thereof.

8. The method of claim 1 wherein progress of the formation of the precipitate is determined by the steps of: adding a fluorophore to the partially treated water prior to the addition of the alkaline calcium reagent, measuring the emission of the fluorophore after addition of the alkaline calcium reagent and correlating the emission with the degree of sulfate precipitated out of the liquid.

9. The method of claim 8 wherein the fluorophore is one item selected from the list consisting of: 1,3,6,8-pyrenetetrasulfonic acid and salts thereof, 1-pyrenesulfonic acid and salts thereof, 1-pyrenecarboxylic acid and salts thereof, 1-pyreneacetic acid and salts thereof, 1-methylaminopyrene and salts thereof, 8-hydroxy-1,3,6-pyrenetrisulfonic acid and salts thereof, 1-aminopyrene and salts thereof, γ-oxo-1-pyrenebutyric acid and salts thereof, 1-naphthalenesulfonic acid and salts thereof, 2-napthalenesulfonic acid and salts thereof, 4-hydroxy-1-naphthalenesulfonic acid and salts thereof, 1,5-naphthalenedisulfonic acid and salts thereof, 1-amino-5-naphthalenesulfonic acid and salts thereof, 6,7-dihydroxy-2-naphthalenesulfonic acid and salts thereof, 6-hydroxy-2-naphthalenesulfonic acid and salts thereof, 1-hydroxy-2-naphthoic acid and salts thereof, 2-hydroxy-1-naphthoic acid and salts thereof, 3-hydroxy-2-naphthoic acid and salts thereof, 2,6-naphthalenedicarboxylic acid and salts thereof, 1-naphthylacetic acid and salts thereof, 1-naphthoxylactic acid and salts thereof, 1-naphthoxyacetic acid and salts thereof, 2-naphthoxyacetic acid and salts thereof, 1-naphthalenephosphonic acid and salts thereof, 1-aminonaphthalene and salts thereof, N-allyl-4-(2-N′,N′-dimethylaminoethoxy)naphthalimide methyl sulfate quaternary salt, SOM fluorescent compound, a polymer containing an SOM fluorescent compound, GQW polymer (red), GQW polymer (purple), and any combination thereof.

10. The method of claim 1 wherein the method further comprises the steps of:
determining the pH of the liquid,
determining the sulfate, concentration of the liquid, and
adding an amount of at least one of alkaline pH generating aluminum agent, acidic to neutral pH generating aluminum agent, and alkaline calcium agent added to the liquid in an amount predetermined to be optimal for the pH and the sulfate concentration of the liquid, wherein the sulfate concentration is determined by adding a fluorophore to the liquid, before adding the acidic to neutral pH generating aluminum agent, measuring the fluorescence of the liquid before and after the addition of the acidic to neutral pH generating aluminum agent, and correlating the change in fluorescence to the concentration of sulfate in the liquid.

11. The method of claim 10 wherein the fluorophore is one item selected from the list consisting of: 1,3,6,8-pyrenetetrasulfonic acid and salts thereof, 1-pyrenesulfonic acid and salts thereof, 1-pyrenecarboxylic acid and salts thereof, 1-pyreneacetic acid and salts thereof, 1-methylaminopyrene and salts thereof, 8-hydroxy-1,3,6-pyrenetrisulfonic acid and salts thereof, 1-aminopyrene and salts thereof, γ-oxo-1-pyrenebutyric acid and salts thereof, 1-naphthalenesulfonic acid and salts thereof, 2-napthalenesulfonic acid and salts thereof, 4-hydroxy-1-naphthalenesulfonic acid and salts thereof, 1,5-naphthalenedisulfonic acid and salts thereof, 1-amino-5-naphthalenesulfonic acid and salts thereof, 6,7-dihydroxy-2-naphthalenesulfonic acid and salts thereof, 6-hydroxy-2-naphthalenesulfonic acid and salts thereof, 1-hydroxy-2-naphthoic acid and salts thereof, 2-hydroxy-1-naphthoic acid and salts thereof, 3-hydroxy-2-naphthoic acid and salts thereof, 2,6-naphthalenedicarboxylic acid and salts thereof, 1-naphthylacetic acid and salts thereof, 1-naphthoxylactic acid and salts thereof, 1-naphthoxyacetic acid and salts thereof, 2-naphthoxyacetic acid and salts thereof, 1-naphthalenephosphonic acid and salts thereof, 1-aminonaphthalene and salts thereof, N-allyl-4-(2-N′,N′-dimethylaminoethoxy)naphthalimide methyl sulfate quaternary salt, SOM fluorescent compound, a polymer containing an SOM fluorescent compound, GQW polymer (red), GQW polymer (purple), and any combination thereof.

12. The method of claim 1 in which the precipitate forms at a rate of at least twice that of an ettringite forming precipitation reaction.

13. The method of claim 1 in which the liquid is from mine drainage effluent (MD), oil well liquid, gas well liquid, oil shale process liquid, alumina refinery effluent, ore processing water, paper production fluids, flue gas desulfurization water, landfill water and industrial process water.

14. The method of claim 1 in which the liquid is pretreated by media filtration, membrane filtration, microfiltration, nanofiltration, reverse osmosis and forward osmosis and any combination thereof.

15. A method of determining the sulfate concentration of a liquid, the method comprising the steps of: adding a fluorophore to the liquid, adding an acidic to neutral pH generating aluminum agent, measuring the fluorescence of the liquid before and after the addition of the acidic to neutral pH generating aluminum agent, and correlating the change in fluorescence to the concentration of sulfate in the liquid.

16. The method of claim 1 in which the precipitate forms at a rate faster than a process which includes more aluminum equivalents but uses either the same acidic to neutral pH generating aluminum agent in the absence of an alkaline pH generating aluminum agent or includes more aluminum equivalents of the same alkaline pH generating aluminum agent in the absence of an acidic to neutral pH generating aluminum agent.
